(19) United States
(12) Patent Application Publication
(10) Pub. No.: US 2019/0124227 A1
(43) Pub. Date: Apr. 25, 2019

(54) IMAGE PROCESSING APPARATUS AND CONTROL METHOD BY THE SAME

(71) Applicant: TOSHIBA TEC KABUSHIKI KAISHA, Tokyo (JP)

(72) Inventor: Sunao TABATA, Sunto Shizuoka (JP)

(21) Appl. No.: 16/116,544

(22) Filed: Aug. 29, 2018

(30) Foreign Application Priority Data
Oct. 24, 2017 (JP) 2017-205555

(51) Int. Cl. H04N 1/00

(52) U.S. Cl. CPC H04N 1/00785; H04N 1/0044; H04N 1/00867; H04N 1/00702

(57) ABSTRACT

An image processing apparatus includes an image sensor that is moved to acquire a region image of a document placement region containing a document placed thereon, processor configured to invert or rotate the image such that the arrangement of a document image contained in the region image is coincident with a placement position of the document on the document placement region in accordance with a main scanning direction of the image sensor, a sub-scanning direction of the image sensor, and a predetermined direction, and a display on which the region image inverted or rotated by the processor is displayed.

### CROSS-REFERENCE TO RELATED APPLICATION

This application is based upon and claims the benefit of priority from Japanese Patent Application No. 2017-205555, filed Oct. 24, 2017, the entire contents of which are incorporated herein by reference.

### FIELD

Embodiments described herein relate generally to an image processing apparatus and a control method by the same.

### BACKGROUND

An image processing apparatus reads a document placed on a document table and displays a thumbnail image based on an image read from the document. The arrangement of the document in the thumbnail image displayed by such an image processing apparatus may be different from the placement of the document on the document table by the user, and thus, there is a problem that it is difficult for the user to recognize a proper placement of the document. When plural documents are placed for execution of multi-crop, if only a part of the documents can be displayed, there is a problem that it is difficult for the user to recognize whether the documents have been properly placed.

### DESCRIPTION OF THE DRAWINGS

FIG. 1 is a perspective external view illustrating an example of an overall configuration of an image processing apparatus;

FIG. 2 is a diagram illustrating an electrical configuration of the image processing apparatus;

FIG. 3 is a diagram illustrating a configuration of an image processing section;

FIG. 4 is a diagram illustrating the positional relationship between a line of sight of a user and an image reading region;

FIG. 5 is a diagram illustrating four patterns of a main scanning direction and a sub-scanning direction when the main scanning direction is parallel to the line of sight of the user;

FIG. 6 is a diagram illustrating scanned images obtained in parallel patterns;

FIG. 7 is a diagram illustrating four patterns of the main scanning direction and the sub-scanning direction when the main scanning direction is orthogonal to the line of sight of the user;

FIG. 8 is a diagram illustrating scanned images obtained in orthogonal patterns;

FIG. 9 is a diagram illustrating a scanning setting screen;

FIG. 10 depict diagrams illustrating different examples of warning when a document is placed in such a manner that it protrudes from the reading region;

FIG. 11 is a diagram illustrating an example applied to a multi-crop process;

FIG. 12 is a diagram illustrating a multi-crop process; and

FIG. 13 is a flowchart for depicting a flow of image processing according to an embodiment.

### DETAILED DESCRIPTION

In accordance with an embodiment, an image processing apparatus includes an image sensor that is moved to acquire a region image of a document placement region containing a document placed thereon, processor configured to invert or rotate the image such that the arrangement of a document image contained in the region image is coincident with a placement position of the document on the document placement region in accordance with a main scanning direction of the image sensor, a sub-scanning direction of the image sensor, and a predetermined direction, and a display on which the region image inverted or rotated by the processor is displayed.

In an image processing apparatus according to the embodiment, it is possible to provide the image processing apparatus by which a user can easily recognize placement status of a document, and a control method by the same. Hereinafter, the image processing apparatus of the embodiment will be described in detail with reference to the accompanying drawings.

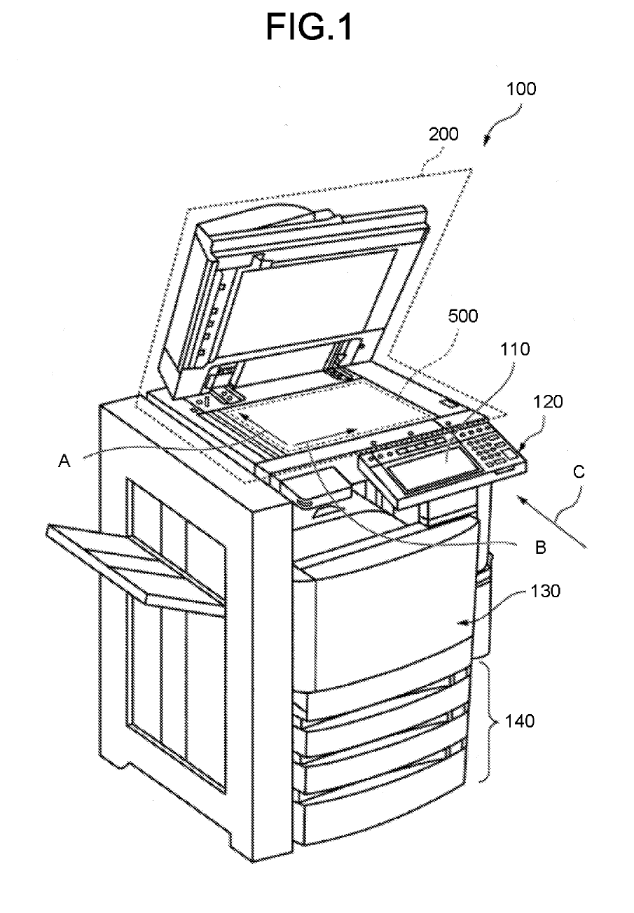

FIG. 1 is a perspective external view illustrating an example of the overall configuration of an image processing apparatus 100 according to the embodiment. The image processing apparatus 100 is, for example, a multi-functional peripheral. The image processing apparatus 100 includes a control panel 120, a printer 130, a sheet storage section 140, and an image reading section 200.

The image processing apparatus 100 forms an image on a sheet using a developer such as a toner. The sheet is, for example, a paper sheet or a label sheet. Any sheet can be used as long as the image processing apparatus 100 can form an image on a surface thereof.

The control panel 120 includes a plurality of buttons and a display 110. The control panel 120 receives an operation input by a user. The control panel 120 outputs a signal in response to an operation executed by the user to a CPU (Central Processing Unit) of the image processing apparatus 100.

The display 110 is an image display device such as a liquid crystal display, an organic EL (Electro Luminescence) display and the like. The display 110 displays various information relating to the image processing apparatus 100.

The printer 130 forms an image on the sheet based on image information generated by the image reading section 200 or image information received through a communication interface. The printer 130 forms an image through the following processes, for example. An image forming section of the printer 130 forms an electrostatic latent image on an outer circumferential surface of a photoconductive drum based on the image information. The image forming section of the printer 130 forms a visible image by attaching a developer to the electrostatic latent image formed on the outer circumferential surface of the photoconductive drum. A transfer section of the printer 130 transfers the visible image onto the sheet. A fixing section of the printer 130 fixes the visible image on the sheet by heating and pressurizing the sheet. The sheet on which the image is formed may be a sheet stored in the sheet storage section 140, or a sheet that is manually fed.

The sheet storage section 140 stores the sheet used in the image formation by the printer 130.

The image reading section 200 acquires a region image by moving a CCD (charge-coupled device) line sensor (hereinafter referred to as “line sensor”) (not shown) in a sub-scanning direction. An arrow A indicates a main scanning direction of the line sensor. An arrow B indicates a sub-scanning direction of the line sensor. An arrow C indicates a line of sight of a user who views an image reading region 500. The image reading section 200 can acquire the region image indicating a region containing a document placed in the image reading region 500. The region image indicates the entire image reading region 500 or a part thereof.

The image reading section 200 is configured to read an image of the document to be read and causes an HDD (Hard Disk Drive) 83 to record the read image information. The recorded image information may be transmitted to another information processing apparatus via a network. The recorded image information may be used to form an image on the sheet by the printer 130.

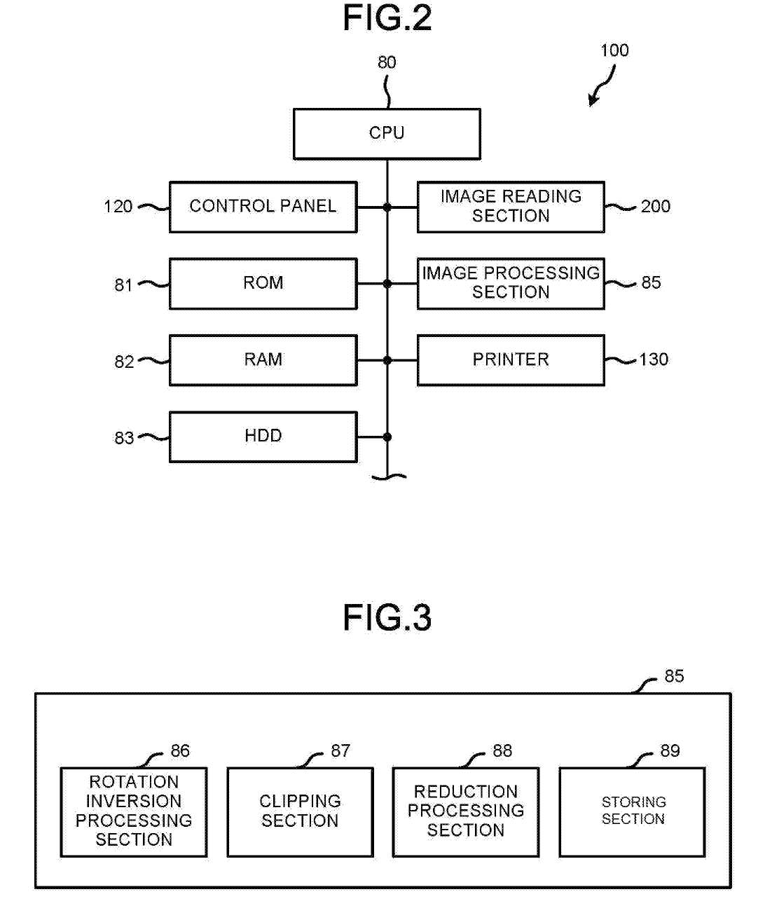

FIG. 2 is a diagram illustrating an electrical configuration of the image processing apparatus 100. The image processing apparatus 100 includes a CPU 80, a control panel 120, a ROM 81, a RAM 82, the HDD 83, the image reading section 200, an image processing section 85, and the printer 130.

The ROM 81 stores various control programs. The RAM 82 stores various data. The hard disk drive 83 stores image data. The image reading section 200 includes a carriage, an exposure lamp, a mirror, a lens block for variable power, a CCD line sensor, and the like, which are not shown. The image processing section 85 performs various processes on the image data acquired by the image reading section 200.

The printer 130 includes an exposure unit, a photoconductive drum, a transfer belt, a driving roller, a driven roller, a primary transfer roller, a secondary transfer roller, a fixing unit, various conveyance paths, and the like, which are not shown. The printer 130 forms an image indicated by the image data processed by the image processing section 85 on the sheet.

FIG. 3 is a diagram illustrating a configuration of the image processing section 85. FIG. 3 depict those processes performed in the present embodiment, and other processes are omitted. The image processing section 85 includes a rotation inversion processing section 86, a clipping section 87, a reduction processing section 88, and a storing section 89. The rotation inversion processing section 86 performs vertical inversion, horizontal inversion, and a rotation process on an image. The clipping section 87 clips an image corresponding to the document from the scanned image. The reduction processing section 88 performs a process for generating reduced image data in order to display a thumbnail image on the display 110. The storing section 89 stores the image clipped by the clipping section 87. A skew process described later is performed by the rotation inversion processing section 86. The image processing section 85 outputs the inverted or rotated region image to the control panel 120 or a PC described later.

Next, the process by the image processing apparatus 100 for inverting or rotating the region image such that the arrangement of the document image is coincident with the placement when the image reading region 500 is viewed from a predetermined direction. A function enabled by this process may be a thumbnail correction function. The document image is an image of the document. For example, if the image exists only in the center of the document, the document image also indicates the image of the entire document. In the following description, the direction of line of sight of a user is used as an example of a predetermined direction. By such a process, a thumbnail image arrangement that is coincident with the placement when viewing the reading region is displayed to the user. With the thumbnail correction function, the user can easily recognize the placement status of the document.

In a case of displaying the placement status of the document with the thumbnail image, images displayed as thumbnail images are different depending on a main scanning direction and a sub-scanning direction of the line sensor, and the line of sight direction. In the following description, it is assumed that the thumbnail image of the document placed in the image processing apparatus 100 shown in FIG. 1 is displayed on another device (for example, PC) located on the user side.

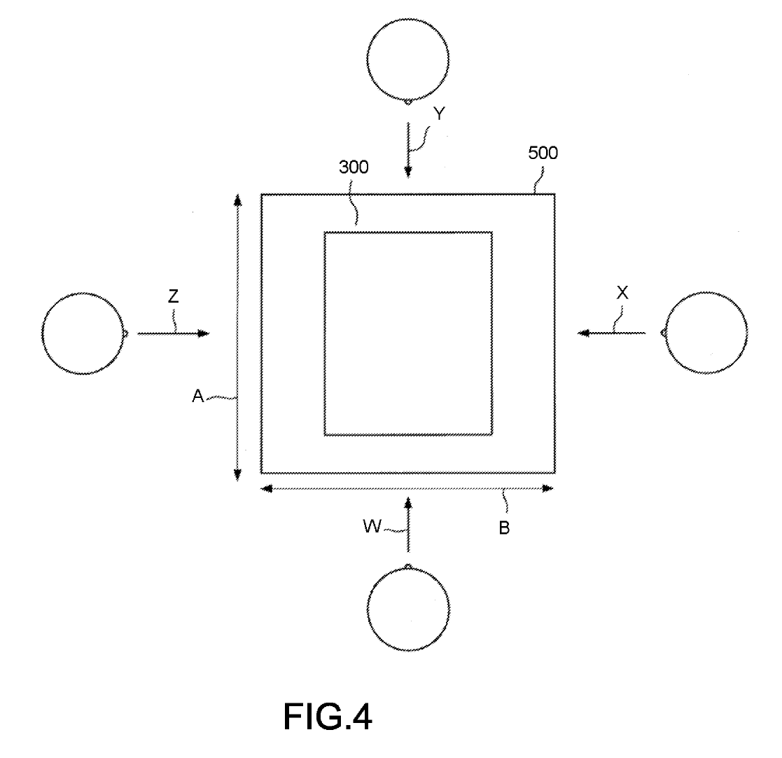

FIG. 4 is a diagram illustrating a positional relationship between the line of sight of the user and the image reading region 500. In the case of displaying the thumbnail image on the PC, the line of sight of the user with respect to the image reading region 500 exists in four directions indicated by arrows XYZW as shown in FIG. 4. In the image reading region 500, the document 300 is placed. An arrow A indicates the main scanning direction and an arrow B indicates the sub-scanning direction. Although the main scanning direction and the sub-scanning direction in the image processing apparatus 100 shown in FIG. 1 are both unidirectional, since there is an image processing apparatus having the main scanning direction and the sub-scanning direction opposite to those directions, in order to cover such a case, a case in which both the main scanning direction and the sub-scanning direction are bidirectional is described in addition to the case in which both are unidirectional. The line of sight of the user is simply expressed as the line of sight in some cases in the following description.

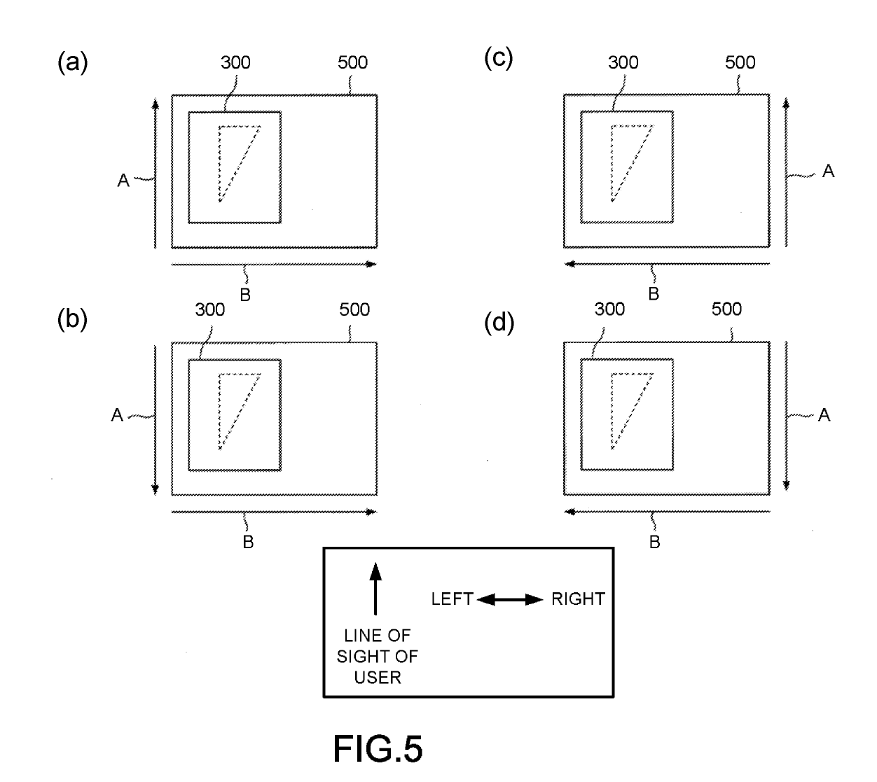

FIG. 5 is a diagram illustrating four patterns of the main scanning direction and the sub-scanning direction when the main scanning direction is parallel to the line of sight of the user. In addition to FIG. 5, in the following description, for ease of explanation, a diagram in which the main scanning direction and the sub-scanning direction are changed while the line of sight of the user is fixed is used.

Each figure shown in FIG. 5 is a diagram obtained by viewing the image reading region 500 from above. Therefore, the placement status that the user normally views is shown. In each figure, a document 300 placed in the image reading region 500 is shown. On the document 300, a triangle indicated by a broken line is drawn as the document image. The triangle is shown by the broken line because it cannot be seen if viewing the image reading region 500 from above. The arrow A indicates the main scanning direction and the arrow B indicates the sub-scanning direction.

FIG. 5 part a shows a pattern when the main scanning direction is coincident with the line of sight and the sub-scanning direction is from left to right. The pattern shown in FIG. 5 part a is expressed as a parallel pattern A in the following description in some cases. FIG. 5 part b shows a pattern when the main scanning direction is opposite to the line of sight and the sub-scanning direction is from left to right. The pattern shown in FIG. 5 part b is expressed as a parallel pattern B in the following description in some cases. FIG. 5 part c shows a pattern when the main scanning direction is coincident with the line of sight and the sub-scanning direction is from right to left. The pattern shown in FIG. 5 part c is expressed as a parallel pattern C in the following description in some cases. FIG. 5 part d shows a pattern when the main scanning direction is opposite to the line of sight and the sub-scanning direction is from right to left. The pattern shown in FIG. 5 part d is expressed as a parallel pattern D in the following description in some cases.

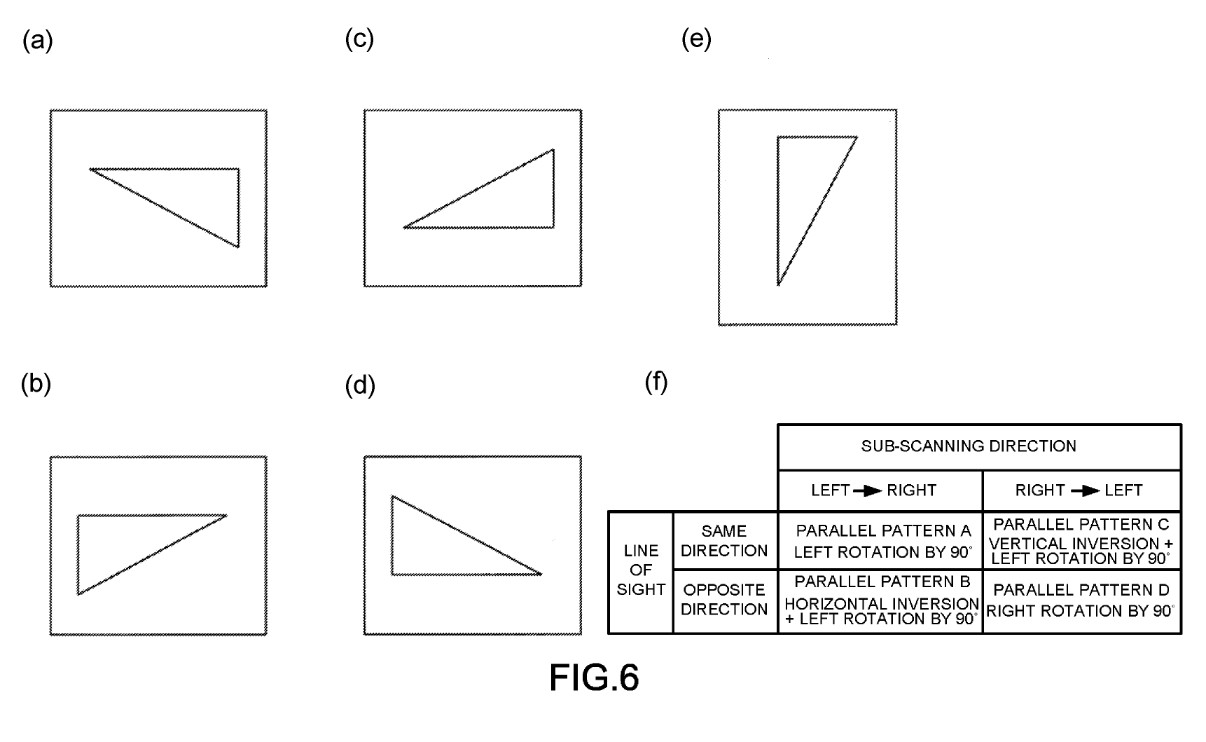

FIG. 6 is a diagram illustrating an image (hereinafter, simply referred to as “scanned image”) indicating the document obtained in the parallel patterns A to D. Since the scanned image is obtained by reading the document in the sub-scanning direction from the position where main scanning is started, a side in the main scanning direction at the start point of the sub-scanning direction becomes an upper side, and a side in the main scanning direction at the end point of the sub-scanning direction is a lower side.

FIG. 6 part a is a diagram illustrating a scanned image obtained in the parallel pattern A. FIG. 6 part b is a diagram illustrating a scanned image obtained in the parallel pattern B. FIG. 6 part c is a diagram illustrating a scanned image obtained in the parallel pattern C. FIG. 6 part d is a diagram illustrating a scanned image obtained in the parallel pattern D.

FIG. 6 part e is a diagram illustrating the thumbnail image to be displayed to the user. FIG. 6 part f shows contents of the image processing on the scanned image. “Same direction” of “line of sight” in FIG. 6 part f indicates that the line of sight is the same as the main scanning direction. “Opposite direction” indicates that the line of sight is opposite to the main scanning direction. The “sub-scanning direction” in FIG. 6 part f indicates a scanning direction from left to right and a scanning direction from right to left.

In the parallel pattern A, the line of sight is same as the main scanning direction, and the sub-scanning direction is the scanning direction from left to right. The image processing in the parallel pattern A is a process of rotating the scanned image 90 degrees to the left. In the parallel pattern B, the line of sight is opposite to the main scanning direction, and the sub-scanning direction is the scanning direction from left to right. The image processing in the parallel pattern B is a process of horizontally inverting the scanned image and further rotating the scanned image 90 degrees to the left. In the parallel pattern C, the line of sight is same as the main scanning direction, and the sub-scanning direction is the scanning direction from right to left. The image processing in the parallel pattern C is a process of vertically inverting the scanned image and further rotating the scanned image 90 degrees to the left. In the parallel pattern D, the line of sight is opposite to the main scanning direction, and the sub-scanning direction is the scanning direction from right to left. The image processing in the parallel pattern D is a process of rotating the scanned image 90 degrees to the right.

Generally, in an XY plane, a vertical inversion with respect to an X-axis, a horizontal inversion with respect to a Y-axis, and a rotational movement around the origin are respectively represented by matrices. The combination of these is expressed with a product of matrices, but the product of matrices is generally not changeable. Therefore, in the case of the image processing including inversion and rotation, it is necessary to perform processes while maintaining the order thereof. For example, in the process of vertically inverting the scanned image and then rotating the scanned image 90 degrees to the left, if a process of rotating the scanned image 90 degrees to the left first, as the upper and lower sides before rotation become left and right sides after rotation, the processing result is not coincident. Furthermore, the image processing in each pattern is not unique. For example, the process of vertically inverting the scanned image and further rotating it by 90 degrees to the left is consistent with a process of rotating the scanned image 90 degrees to the left and further horizontally inverting the scanned image.

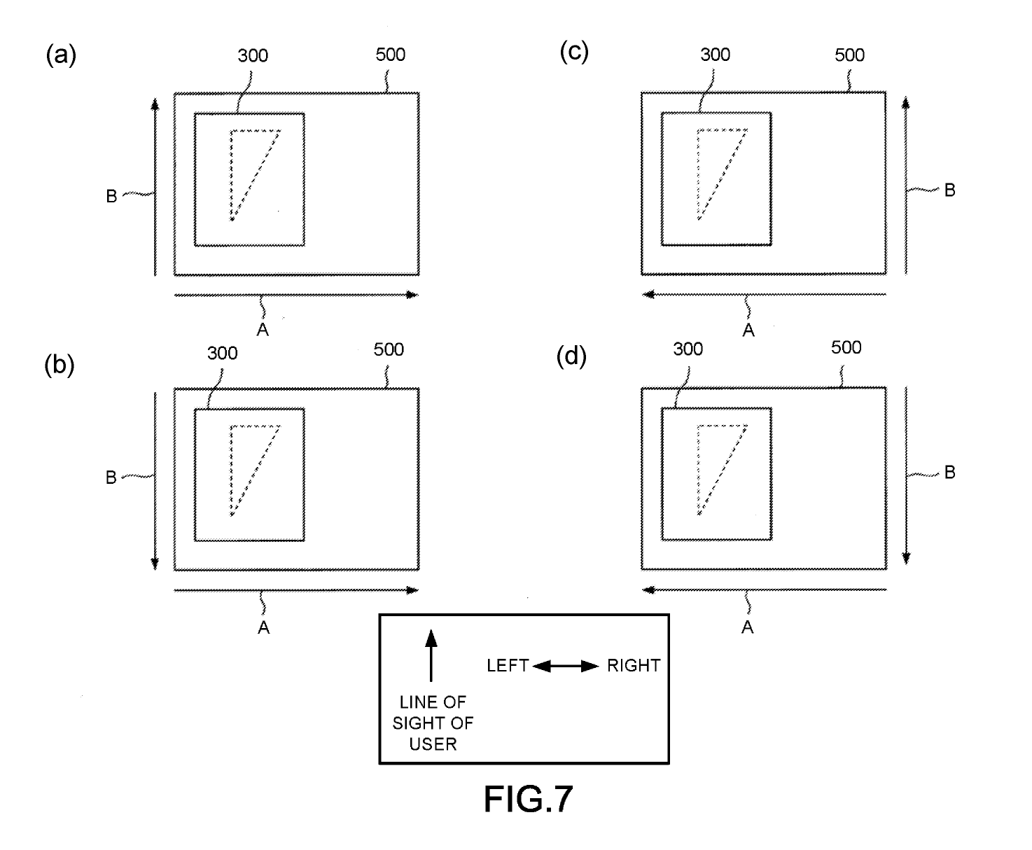

FIG. 7 is a diagram illustrating four patterns of the main scanning direction and the sub-scanning direction when the main scanning direction is orthogonal to the line of sight of the user.

Each figure shown in FIG. 7 is a diagram obtained by viewing the image reading region 500 from above. In each figure, the document 300 placed on the image reading region 500 is shown. Therefore, the placement status that the user normally views is shown. In the document 300, a triangle shown by a broken line is drawn. The triangle is shown by the broken line because it cannot be seen if the image reading region 500 is viewed from above. The arrow A indicates the main scanning direction and the arrow B indicates the sub-scanning direction.

FIG. 7 part a shows a pattern when the sub-scanning direction is coincident with the line of sight and the main scanning direction is from left to right. The pattern shown in FIG. 7 part a is expressed as an orthogonal pattern A in the following description in some cases. FIG. 7 part b shows a pattern when the sub-scanning direction is opposite to the line of sight and the main scanning direction is from left to right. The pattern shown in FIG. 7 part b is expressed as an orthogonal pattern B in the following description in some cases. FIG. 7 part c shows a pattern when the sub-scanning direction is coincident with the line of sight and the main scanning direction is from right to left. The pattern shown in FIG. 7 part c is expressed as an orthogonal pattern C in the following description in some cases. FIG. 7 part d shows a pattern when the sub-scanning direction is opposite to the line of sight and the main scanning direction is from right to left. The pattern shown in FIG. 7 part d is expressed as an orthogonal pattern D in the following description in some cases.

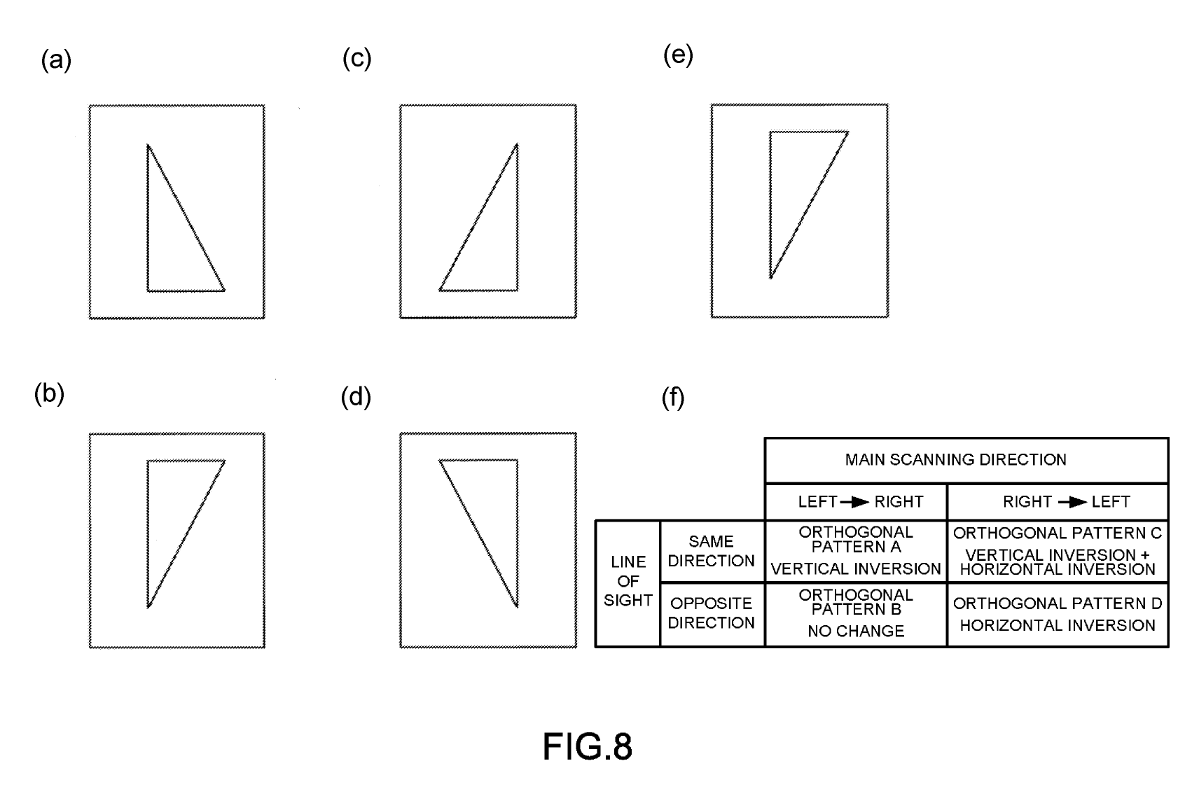

FIG. 8 is a diagram illustrating scanned images obtained in the orthogonal patterns A to D. Since the scanned image is read in the main scanning direction from the position where the main scanning is started, a side in the sub-scanning direction at the start point of the main scanning direction is an upper side, and a side in the sub-scanning direction at the end point of the main scanning direction is a lower side.

FIG. 8 part a is a diagram illustrating a scanned image obtained in the orthogonal pattern A. FIG. 8 part b is a diagram illustrating a scanned image obtained in the orthogonal pattern B. FIG. 8 part c is a diagram illustrating a scanned image obtained in the orthogonal pattern C. FIG. 8 part d is a diagram illustrating a scanned image obtained in the orthogonal pattern D.

FIG. 8 part e is a diagram illustrating a thumbnail image to be displayed to the user. FIG. 8 part f shows convents of the image processes on the scanned image. “Same direction” of the “line of sight” in FIG. 8 part f indicates that the line of sight is same as the sub-scanning direction. “Opposite direction” indicates that the line of sight is opposite to the sub-scanning direction. The “main scanning direction” in FIG. 8 part f shows a scanning direction from left to right and a scanning direction from right to left.

In the orthogonal pattern A, the line of sight is the same as the sub-scanning direction, and the main scanning direction is the scanning direction from left to right. The image processing in the orthogonal pattern A is a process of vertically inverting the scanned image. In the orthogonal pattern B, the line of sight is the opposite the sub-scanning direction, and the main scanning direction is the scanning direction from left to right. In the orthogonal pattern B, as the thumbnail image to be displayed is coincident with the scanned image, neither the inversion process nor the rotation process is executed. In the orthogonal pattern C, the line of sight is the same as the sub-scanning direction, and the main scanning direction is the scanning direction from right to left. The image processing in the orthogonal pattern C is a process of vertically inverting the scanned image and then horizontally inverting the scanned image. In the orthogonal pattern D, the line of sight is opposite to the sub-scanning direction, and the main scanning direction is the scanning direction from right to left. The image processing in the orthogonal pattern D is a process of horizontally inverting the scanned image.

The combination of the line of sight, the main scanning direction, and the sub-scanning direction is any one of the eight patterns (the parallel patterns A to D, and the orthogonal patterns A to D) shown in FIG. 6 to FIG. 8, and thus, the patterns and the image processes corresponding to those patterns shown in FIG. 6 part f and FIG. 8 part f are previously stored in a storage device such as the HDD 83. Then, the image processing apparatus 100 performs the image processing corresponding to the pattern. In other words, the image processing apparatus 100 inverts or rotates the region image so that the arrangement of the document image is coincident with the placement when viewing the reading region from the line of sight. The rotated or inverted image is reduced by the reduction processing section 88 for the use as the thumbnail image. The scanned image is also stored by the storing section 89.

In this way, the image processing section 85 inverts or rotates the region image based on the main scanning direction, the sub-scanning direction, and the predetermined direction. By the thumbnail correction function, as the image in which the arrangement of the document image is coincident with the placement when viewing the image reading region 500 from the line of sight is displayed as the thumbnail image, the user can easily recognize the placement status of the document.

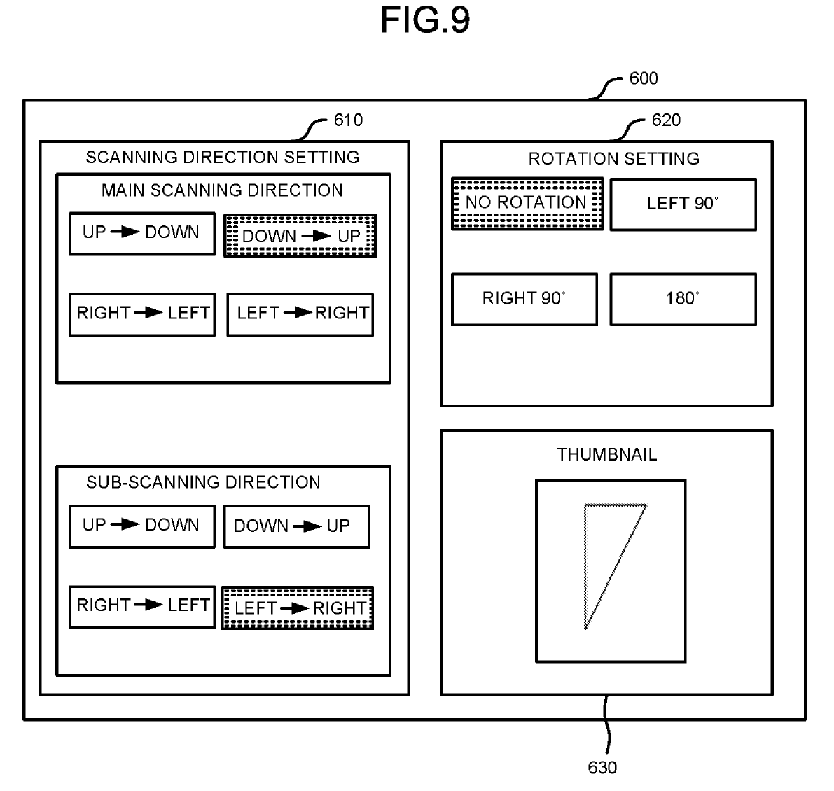

FIG. 9 is a diagram illustrating a scanning setting screen 600. The scanning setting screen 600 is displayed on the PC displaying the thumbnail image. The scanning setting screen 600 includes a scanning direction setting section 610, a rotation setting section 620, and a thumbnail display section 630. The scanning direction setting section 610 sets the main scanning direction and the sub-scanning direction viewed from the user. The rotation setting section 620 rotates the scanned image. The thumbnail display section 630 displays the thumbnail image with which the user can recognize the placement status of the document. In the thumbnail display section 630, when the rotation setting section 620 selects a process other than “no rotation”, a thumbnail image of the scanned image which is rotated is displayed.

The PC transmits the main scanning direction, the sub-scanning direction and the rotation setting to the image processing apparatus 100 if the main scanning direction, the sub-scanning direction and the rotation setting input by the user are acquired. The image processing apparatus 100 performs the image processing in response to the pattern corresponding to the main scanning direction and the sub-scanning direction, thereby obtaining the image in which the arrangement of the document image is coincident with the placement when viewing the image reading region 500 from the line of sight. The obtained image is reduced by the reduction processing section 88 and then transmitted to the PC. The PC displays the received image on the thumbnail display section 630.

As described above, according to the present embodiment, the user can easily recognize the placement status of the document. Next, an application example of the thumbnail correction function is described. In the above-described embodiment, the image processing apparatus 100 and the PC are used to describe each pattern in which the scanning directions and the line of sight are different. However, in the following example, the image processing apparatus 100 has the thumbnail correction function for performing display on the display 110.

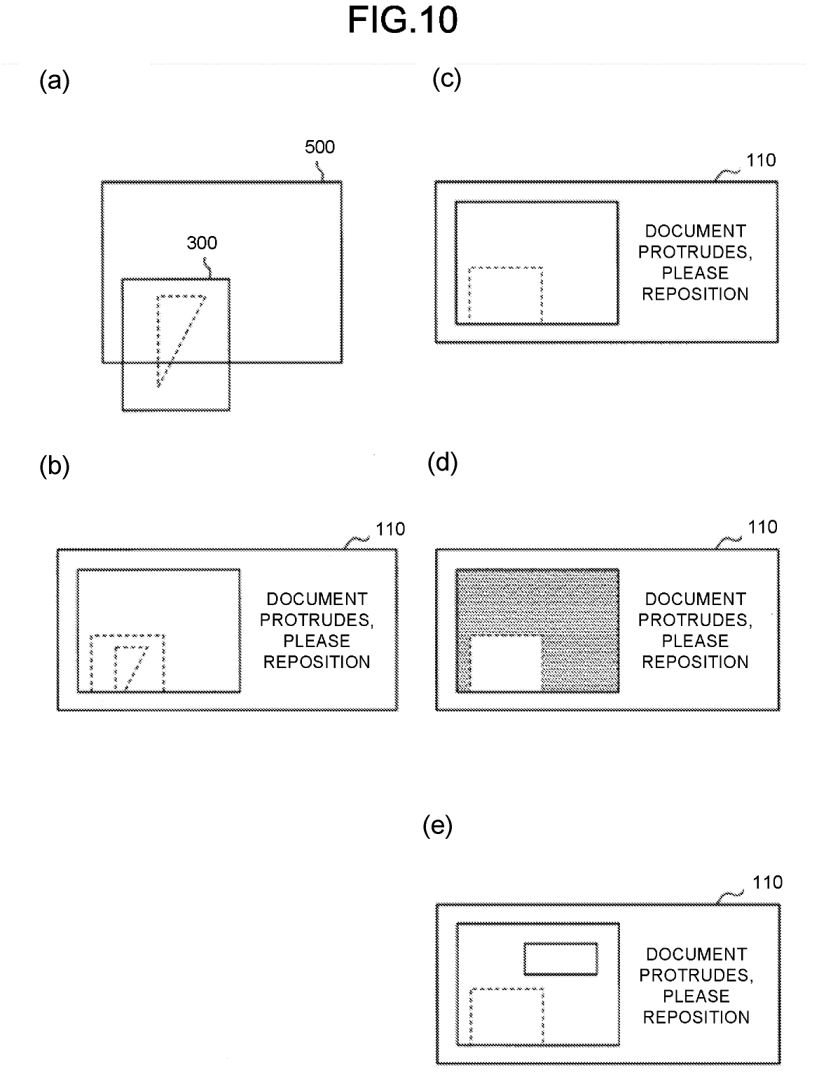

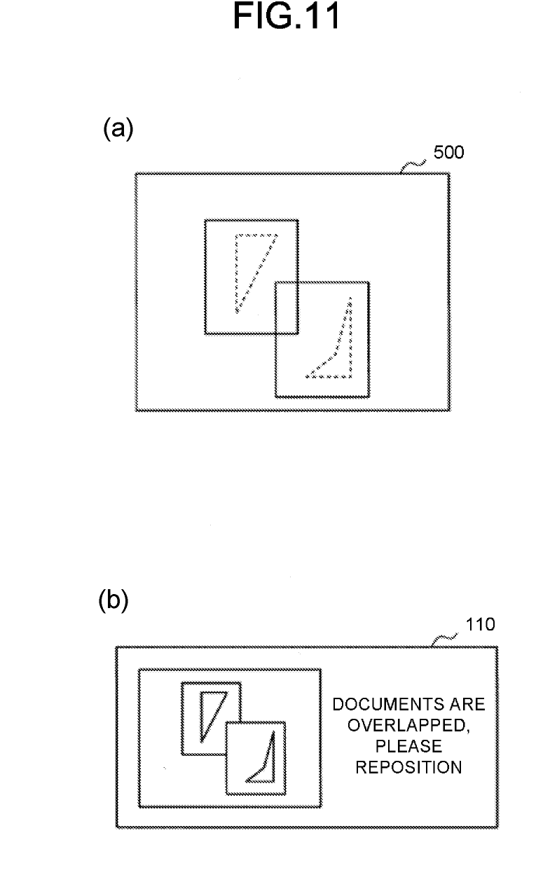

FIG. 10 is a diagram illustrating a warning example when the document is placed in such a manner that it protrudes from the image reading region 500. As shown in FIG. 10 part a, a lower part of the document 300 placed in the image reading region 500 protrudes from the image reading region 500. If a thumbnail image which is not coincident with the arrangement of the document is displayed in such a date, it is difficult for the user to intuitively understand how to reposition the document. Thus, by displaying the thumbnail image coincident with the placement of the document using the thumbnail correction function, the user can easily intuitively understand how to reposition the document, leading to remarkable improvement in usability for the user.

FIG. 10 part b to FIG. 10 part d are diagrams illustrating different examples of a warning screen. A warning message “the document protrudes, please reposition the document” and the thumbnail image are displayed in all warning screens in FIG. 10 part b to FIG. 10 part d. The thumbnail image is generated by the image processing section 85. FIG. 10 part b shows a warning screen displaying the position of the document together with the document image. FIG. 10 part c shows a warning screen for displaying the position of the document. FIG. 10 part d shows a warning screen for displaying the region of the document and a region other than the region of the document. FIG. 10 part e shows a warning screen of a case in which two documents are placed, and only the document protruding is indicated by the broken line, which is different from FIG. 10 part b to FIG. 10 part d.

Since the thumbnail image coincident with the placement of the document is displayed due to the thumbnail correction function in any one of the warning screens, the user can easily intuitively understand how to reposition the document, leading to remarkable improvement in usability for the user.

Next, an example in which the thumbnail correction function is applied to a multi-crop is described. In the multi-crop, plural documents are placed in the reading region 500. In this case, the documents overlap with each other in some cases. FIG. 11 is a diagram illustrating an application example to the multi-crop. FIG. 11 part a shows a state in which the documents are placed in an overlapped manner. FIG. 11 part b shows a warning screen. On the warning screen, a warning message “the documents overlap, please reposition the documents” and the thumbnail image of the overlapped documents are displayed. Since an overlapped state is also displayed on the thumbnail image as shown in FIG. 11 part b, the user can easily intuitively understand how to reposition the document, leading to remarkable improvement in usability for the user. In this manner, the image processing section 85 performs the image processing on the region image such that the region of the document image in the region image and the region other than the region of the document image are recognizable.

In the multi-crop, many documents are placed in some cases, and in this case, plural documents may protrude from the image reading region 500. In such a case, if a thumbnail image that is not coincident with the placement when viewing the image reading region 500 from the line of sight is displayed, it is very difficult for the user to understand how to reposition the document. Therefore, by displaying the thumbnail image coincident with the placement of the document using the thumbnail correction function, the user can easily intuitively understand how to reposition the document, leading to remarkable improvement in usability for the user.

The image indicating the document protruding in FIG. 10 and the image indicating the documents overlapping with each other in FIG. 11 may be displayed in a color different from the background (for example, the document is displayed in red if the background is displayed in white). In FIG. 10 part c to FIG. 10 part e, since the document image is not displayed and only the positional relationship is displayed, the positional relationship becomes easier to understand as compared with a case in which the document image is also displayed.

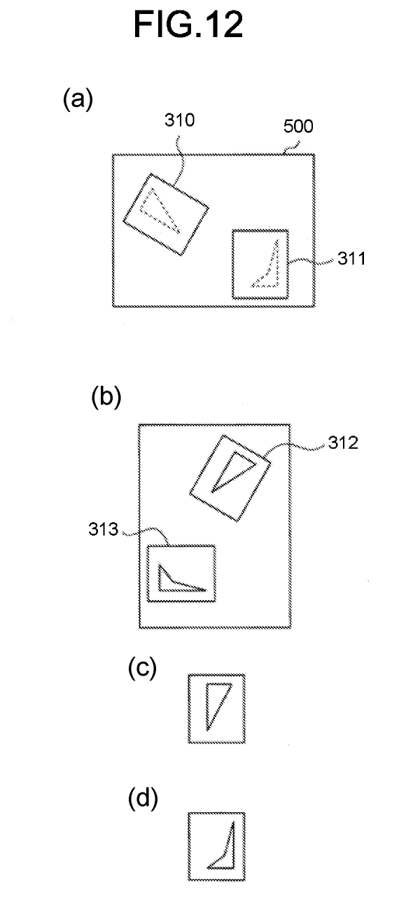

Next, the multi-crop process according to the present embodiment is described. FIG. 12 is a diagram illustrating the multi-crop process. FIG. 12 part a shows documents 310 and 311 placed in the image reading region 500. FIG. 12 part b shows a scanned image. An image 313 shown in the scanned image is an image indicating the document 311 and an image 312 is an image indicating the document 310.

By clipping the images 312 and 313, rectangular images are obtained. In the present embodiment, when the clipped image is tilted, a skew process is performed and the shorter side is set as the upper side. Since there are two shorter side, there are two rotation methods; however, the skew process is performed according to the rotation method in which a rotation angle is smaller. If the rotation angles in two rotation methods are equal to each other, i.e., if the rotation angle is 90 degrees, the skew process is performed in the left direction by 90 degrees.

An image obtained by clipping the image 312 is stored by the storing section 89 in a form shown in FIG. 12 part c. The image obtained by clipping the image 313 is stored by the storing section 89 in a form shown in FIG. 12 part d. In this way, the image processing section 85 clips the document image from the region image. In the above-described multi-crop process, it is possible to clip an image indicating the document with higher accuracy if a platen cover is opened when compared with a case in which the platen cover is not opened.

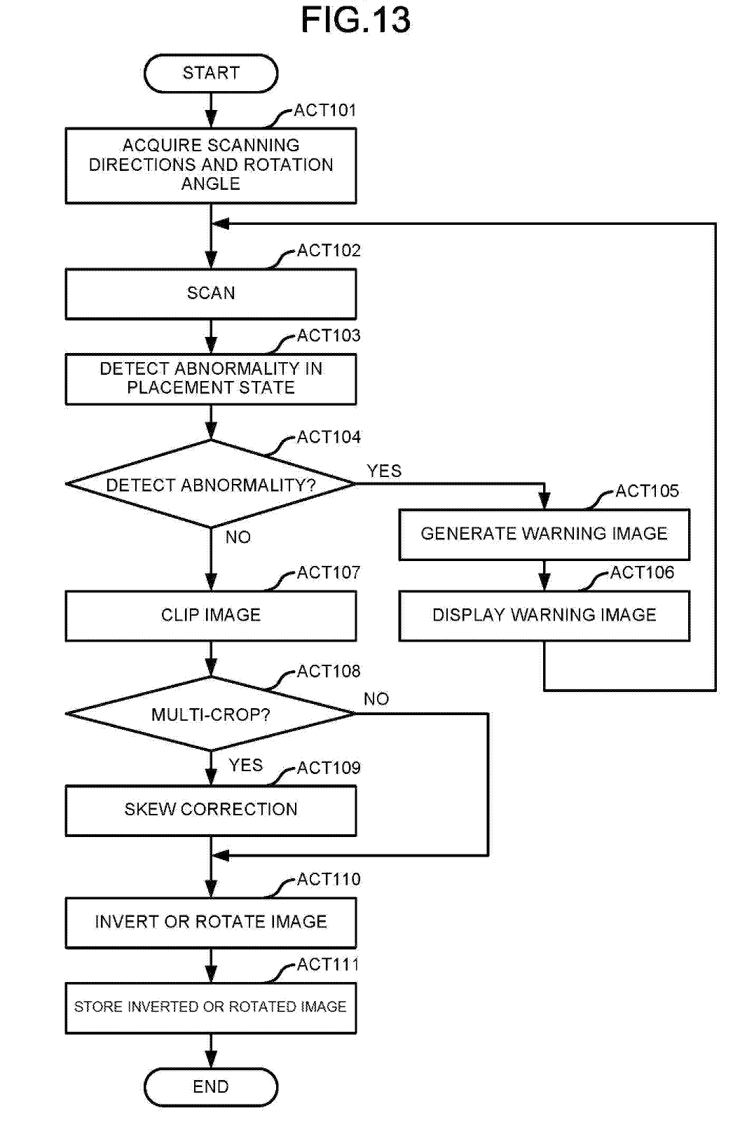

FIG. 13 is a flowchart for depicting the flow of a process by the image processing apparatus. The CPU 80 acquires the scanning directions and the rotation angle (ACT 101). As described above, if the scanning directions and the rotation angle are received from the PC, the scanning directions and the rotation angle are acquired from the PC. In other words, the scanning directions and the rotation angle may be controlled from the PC. On the other hand, if the image processing is performed only by the image processing apparatus 100, since the scanning directions are fixed, the CPU 80 acquires the predetermined scanning directions.

The CPU 80 performs scanning (ACT 102) and detects an abnormality in the placement state (ACT 103). In ACT 103, the protrusion of the document, or the overlap of the documents described above is regarded as an abnormality, and the abnormality can be detected. The CPU 80 determines whether or not the abnormality is detected (ACT 104). If the abnormality is detected (Yes in ACT 104), the CPU 80 generates the warning screen shown in FIG. 10 or FIG. 11 (ACT 105) and displays the generated warning screen (ACT 106). The CPU 80 performs the scanning again (ACT 102) by closing the platen cover or operating the control panel 120.

If no abnormality is detected in ACT 104 (No in ACT 104), the CPU 80 clips the image (ACT 107). Here, the clipping of the image refers to clipping of an image of a size if the size of the document is detected or the size is designated by the user. If the size of the document is not detected and is not designated by the user, a region corresponding to the document is clipped.

The CPU 80 determines whether or not the multi-crop is performed (ACT 108). In ACT 108, if a plurality of images is clipped by the clipping in ACT 107, it is determined that the multi-crop is performed. If it is determined that the multi-crop is performed (Yes in ACT 108), the CPU 80 performs the above-described skew correction (ACT 109) and proceeds to the process in ACT 110.

If it is determined that the multi-crop is not performed (No in ACT 108), the CPU 80 inverts or rotates the image based on the main scanning direction, the sub-scanning direction, and the predetermined direction (ACT 110). The CPU 80 stores the clipped image (ACT 111), and ends the present process.

According to the image processing apparatus 100 of the embodiment described above, it is possible to provide the image processing apparatus with which the user can easily recognize the placement status of the document.

The image processing apparatus 100 in the above embodiment can acquire an image illustrating a part of the region or the entire region of the image reading region 500 as the region image. Accordingly, for example, if the size of the document is designated by the user, an image indicating the region of the designated size may be acquired as the region image, alternatively, an image indicating the entire image reading region 500 may be acquired as the region image and then the image indicating the region of the designated size is clipped.

The functions of the image processing apparatus according to the foregoing embodiments may be realized by a computer. In this case, programs for realizing the functions are recorded in a computer-readable recording medium, and the functions may be realized by reading the programs in the computer-readable recording medium into a computer system and then executing them. Further, it is assumed that the “computer system” described herein contains an OS (operating system) or hardware such as peripheral devices. Further, the “computer-readable recording medium” refers to a portable medium such as a flexible disc, a magneto-optical disk, a ROM, a CD-ROM and the like or a storage device such as a hard disk built in the computer system. Furthermore, the “computer-readable recording medium” refers to a medium for dynamically holding the programs for a short time like a communication wire in a case in which the programs are sent via a communication line such as a network like the Internet or a telephone line. The “computer-readable recording medium” may hold the programs for a certain time like a volatile memory in the computer system serving as a server and a client. The foregoing programs may realize a part of the above-mentioned functions, or the above mentioned functions may be realized by the combination with a program already recorded in the computer system.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image processing apparatus, comprising:
an image sensor that is moved to acquire a region image of a document placement region containing a document placed thereon;
a processor configured to invert or rotate the image such that the arrangement of a document image contained in the region image is coincident with a placement position of the document on the document placement region in accordance with a main scanning direction of the image sensor, a sub-scanning direction of the image sensor, and a predetermined direction; and
a display on which the region image inverted or rotated by the processor is displayed.

2. The image processing apparatus according to claim 1, wherein the predetermined direction is a line of sight direction of a user viewing the document placement region.

3. The image processing apparatus according to claim 2, wherein the image sensor is a line sensor that has a plurality of sensors arranged along the main scanning direction and the image sensor is moved in the sub-scanning direction to acquire the region image.

4. The image processing apparatus according to claim 1, wherein the processor is configured to perform image processing on the region image so that the document image is displayed within the region image to be distinguishable from rest of the region image.

5. The image processing apparatus according to claim 1, wherein the processor is configured to clip the document image from the region image and store the clipped image in a storage device.

6. The image processing apparatus according to claim 1, wherein the main scanning direction of the image sensor and the sub-scanning direction of the image sensor are variable and acquired from inputs external to the image processing apparatus.

7. The image processing apparatus according to claim 1, wherein the main scanning direction of the image sensor and the sub-scanning direction of the image sensor are fixed.

8. The image processing apparatus according to claim 1, wherein the processor is configured to invert the image with respect to a horizontal axis or a vertical axis in accordance with the main scanning direction of the image sensor, the sub-scanning direction of the image sensor, and the predetermined direction.

9. The image processing apparatus according to claim 1, wherein the processor is configured to rotate the image clockwise or counterclockwise by 90 degrees in accordance with the main scanning direction of the image sensor, the sub-scanning direction of the image sensor, and the predetermined direction.

10. The image processing apparatus according to claim 1, wherein a thumbnail image of the region image inverted or rotated by the processor is displayed.

11. A control method carried out by an image processing apparatus, comprising:
moving an image sensor to acquire a region image of a document placement region containing a document placed thereon;
inverting or rotating the region image such that the arrangement of a document image contained in the acquired region image is coincident with the placement position of the document on the document placement region in accordance with a main scanning direction of the image sensor, a sub-scanning direction of the image sensor, and a predetermined direction; and
displaying the region image inverted or rotated on a display device.

12. The control method according to claim 11, wherein the predetermined direction is a line of sight direction of a user viewing the document placement region.

13. The control method according to claim 12, wherein the image sensor is a line sensor that has a plurality of sensors arranged along the main scanning direction and is moved in the sub-scanning direction to acquire the region image.

14. The control method according to claim 11, further comprising:
performing image processing on the region image so that the document image is displayed within the region image to be distinguishable from rest of the region image.

15. The control method according to claim 11, further comprising:
clipping the document image from the region image; and
storing the clipped image in a storage device.

16. The control method according to claim 11, wherein the main scanning direction of the image sensor and the sub-scanning direction of the image sensor are variable and acquired from external inputs.

17. The control method according to claim 11, wherein the main scanning direction of the image sensor and the sub-scanning direction of the image sensor are fixed.

18. The control method according to claim 11, wherein the image is inverted with respect to a horizontal axis or a vertical axis in accordance with the main scanning direction of the image sensor, the sub-scanning direction of the image sensor, and the predetermined direction.

19. The control method according to claim 11, wherein the image is rotated clockwise or counterclockwise by 90 degrees in accordance with the main scanning direction of the image sensor, the sub-scanning direction of the image sensor, and the predetermined direction.

20. The control method according to claim 11, wherein a thumbnail image of the region image that is inverted or rotated is displayed.
